(19) United States
(12) Patent Application Publication
(10) Pub. No.: US 2016/0223287 A1
(43) Pub. Date: Aug. 4, 2016

(54) Interchangeable Ballistic Data Apparatus

(71) Applicant: Harley Loyd Swindoll, JR., Hernando, MS (US)

(72) Inventor: Harley Loyd Swindoll, JR., Hernando, MS (US)

(21) Appl. No.: 14/613,689

(22) Filed: Feb. 4, 2015

(51) Int. Cl. F41C 27/00; G09F 3/18

(52) U.S. Cl. CPC F41C 27/00; G09F 3/18

(57) ABSTRACT

A device to be used in association with firearms. The device allows the user of a firearm to determine the change in a projectile's trajectory over a given distance, allowing the user to compensate for the change. The device encloses a ballistic data chart, holding it in place while permitting the user to view the ballistic data chart. The device is configured to allow the ballistic data chart to be removed and replaced to accommodate different ammunition configurations. The device is attached to the firearm in a manner that allows it to be removed from a firearm and attached to another.

### REFERENCE CITED

5,546,691; 3,826,012; 7,325,353; 3,990,155; 8,584,944; 6,196,455; 4,248,496; 8,500,016; EP 18 04017; DE 3,622,901

### FIELD OF THE INVENTION

The present teachings relate generally to a device that attaches to a firearm, and, more particularly, to a device that holds a ballistic data chart containing information related to the projectile being fired from the firearm.

### BACKGROUND OF THE INVENTION

A firearm user, attempting to hit a distant target, encounters many factors in the field that affect the firearm's aim point. One factor is the projectile's change in trajectory as it travels over a given distance. The rate of the projectile's changing trajectory depends, in part, on the type of firearm and ammunition used. There exists a need for a device that allows a firearm user to store data related to the trajectory of a given firearm's ammunition in a manner that permits the firearm user to access that data in the field.

It is common for a firearm user to carry other equipment when shooting, so an opportunity to lessen the amount of equipment can be of utmost importance. Thus, there also exists a need for a device that allows trajectory data to be stored in a manner that allows it to be attached to the firearm, eliminating the need to add separate equipment.

Many firearm users own multiple firearms and utilize multiple types of ammunition with each firearm, depending on the target's size, range, and nature. Accordingly there exists a need for a device that allows a firearm user to change the trajectory data stored in the device to suit the type of firearm that the device is attached to and the type of ammunition being used.

Other known ballistic data charts currently being used by shooters include a device that attaches to the firearm and utilizes a cylindrical casing to hold the trajectory data. This device allows a shooter to calculate the change in trajectory for a single type of ammunition, see for example, U.S. Pat. 5,546,691. However, this known device is flawed in that it does not permit the shooter to change the ballistic data to accommodate different types of ammunition that the shooter may choose to use with a single firearm. The known device is also flawed in that it does not permit the shooter to use it with another firearm having a different type of ammunition.

A need remains for a device that holds a ballistic data chart in a manner so that it is easily viewable in the field. A need remains for a device that permits the shooter to remove the ballistic data chart and replaced it with another ballistic data chart to accommodate different types of ammunition shot from a single firearm or a different firearm. A need remains for a device that permits the shooter to remove the ballistic data chart holder from one firearm and place it on another firearm. The present device was developed to satisfy this previously unmet need.

### SUMMARY OF THE INVENTION

The present invention relates to a device that holds a ballistic data chart while being attached to a firearm. In accordance with another aspect of the invention, the device permits the shooter to view the ballistic data chart while it remains in the holder. In accordance with another aspect of the invention, the device permits the removal and replacement of a ballistic data chart from the holder to accommodate data that relates to different types of ammunition being fired from a single firearm. In accordance with another aspect of the invention, the device may be removed from one firearm and attached onto another firearm.

The described device thus effectively holds the ballistic data chart so that it can be read by the shooter in the field, while maintaining the ability to change the ballistic data chart to accommodate different ammunition shot from a single firearm and detach the device from one firearm so that it can be attached to a different firearm.

A further advantage of the present device will become readily apparent to those skilled in this art from the following detailed description, wherein the present device is shown and described in only the preferred embodiment of the device, simply by way of illustration of the device's best mode for carrying out its objectives. As will be realized, the device is capable of other and different embodiments, and its several details are capable of modifications in various obvious respects, all without departing from the device. Accordingly, the drawing and description are to be regarded as illustrative in nature, and not as restrictive.

### BRIEF DESCRIPTION OF THE DRAWINGS

FIG. 1 is a front view of the device of the present embodiments that has been unfolded, disassembled, and detached form the firearm.

FIG. 2 is a front view of the assembled device of the present embodiment that has been unfolded and detached from the firearm.

FIG. 3 is a back view of the assembled device of the present embodiment shown in FIG. 2.

FIG. 4 is a front view of the device of the present embodiments folded and attached to the firearm.

FIG. 5 is a front view of the device of the present embodiment folded and attached to the firearm and secured using a lanyard.

FIG. 6 is a rear view of the device of the present embodiment shown in FIG. 5.

FIG. 7 is a top elevation view of the device in its present embodiment shown in FIG. 5.

### DETAILED DESCRIPTION OF THE PREFERRED EMBODIMENTS

The present teachings relate to a device that can be used by someone operating a firearm, the shooter, to hold a ballistic data chart containing information about trajectory of the projectile being fired from the firearm to which it is attached. The holder can be attached to the firearm's sling but the present teachings can find alternative places to mount the holder onto the firearm.

The device, without the assistance of any other device, is capable of displaying information to the shooter easily in the field to refresh the shooter's recollection of the ballistic data prior to his calculation of the projectile's change in trajectory between the firearm and the target. The device allows the shooter to customize the ballistic data to correspond to the ammunition being fired from the firearm.

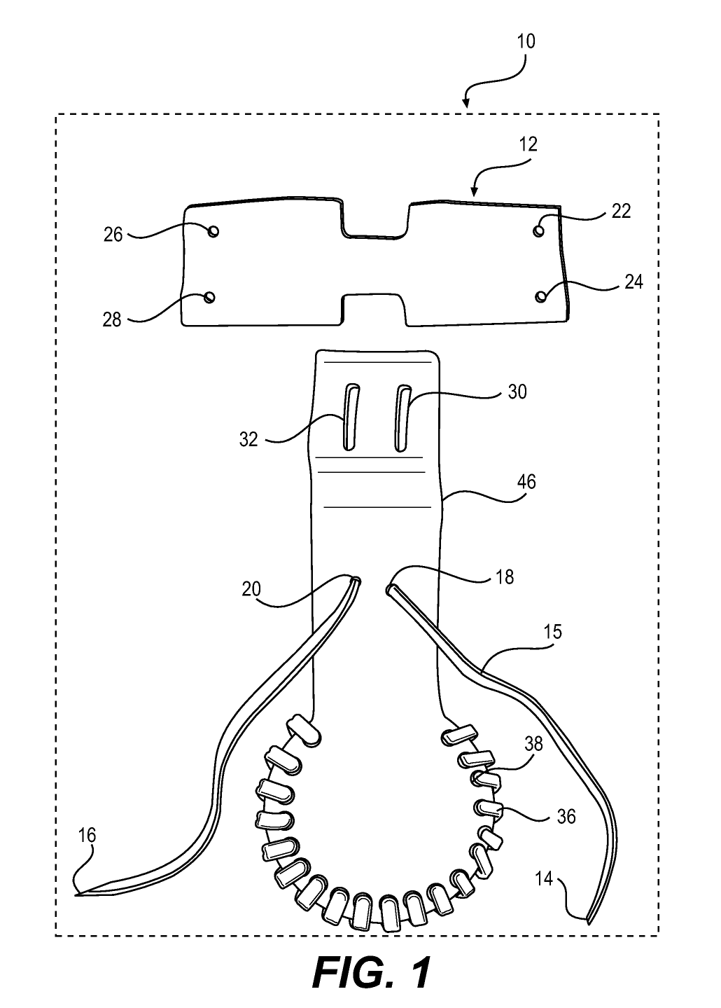

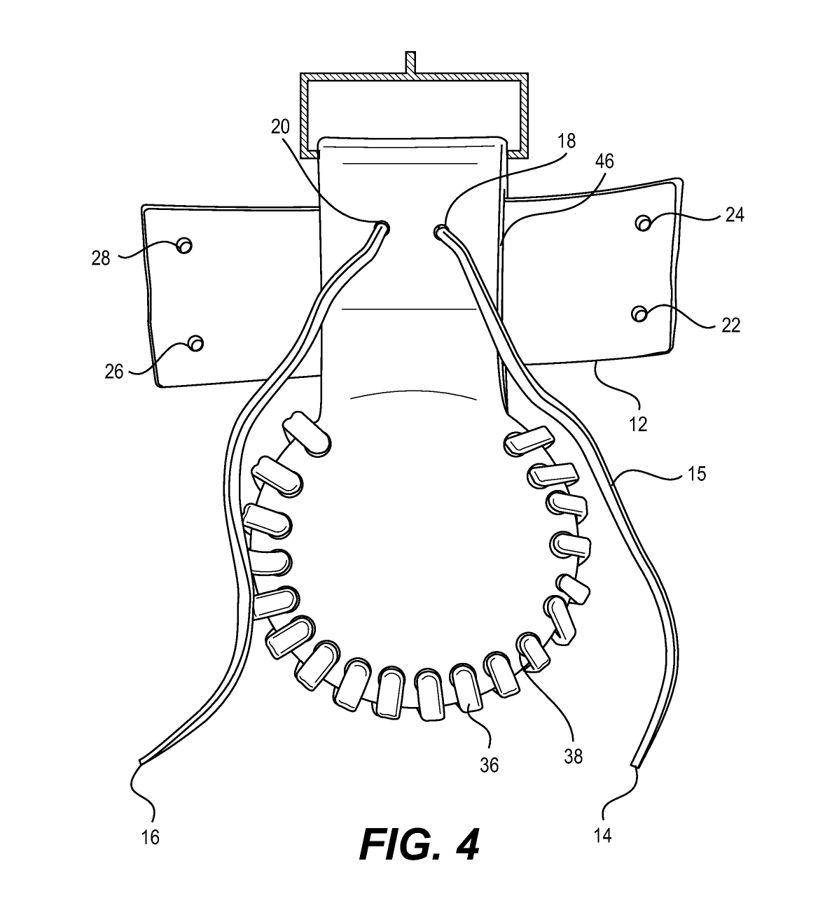

FIGS. 1-7 illustrate a ballistic data holder 10 in accordance with the present embodiment. FIGS. 1-3 are drawn so that the holder 10 is unfolded as it appears when detached from the firearm. FIGS. 4-7 are drawn so that the older 10 is folded around a ring attached to a rifle, such as those commonly used to secure a sling to a rifle. As shown in FIG. 1, the ballistic data holder 10 comprises a single piece of leather 46 cut in the shape of a partial circle extending down from a neck with an approximate length of twice the diameter of the partial circle which includes a hole punch 18 approximately midway along the neck of the leather piece 46 slightly right of center and a second hole punch 20 approximately midway along the neck of the leather piece 46 slightly left of center and a leather lanyard 15 with one end 16 inserted through hole punch 20 and one end 14 inserted through hole punch 18 and a vertically cut slit 30 located near the top of the neck of the leather piece 46 slightly to the right of center and a vertically cut slit 32 located near the top of the leather piece 46 to the left of center and in line horizontally with vertical slit 30.

The ballistic data holder 10 comprises a second piece of leather 12 cut into a shape of a barbell and a hole punch 22 in approximately the upper right hand corner of the leather piece 12 a hole punch 24 in approximately the lower right hand corner of the leather piece 12 a hole punch 26 in approximately the upper left hand corner of the leather piece 12 and a hole punch 28 in approximately the lower left hand corner of the leather piece 28. The vertically cut slits 30 and 32 of the first leather piece 46 should be large enough for the larger portion of the second leather piece 12 to pass through them and approximately the same width as the middle portion of the second leather piece 12.

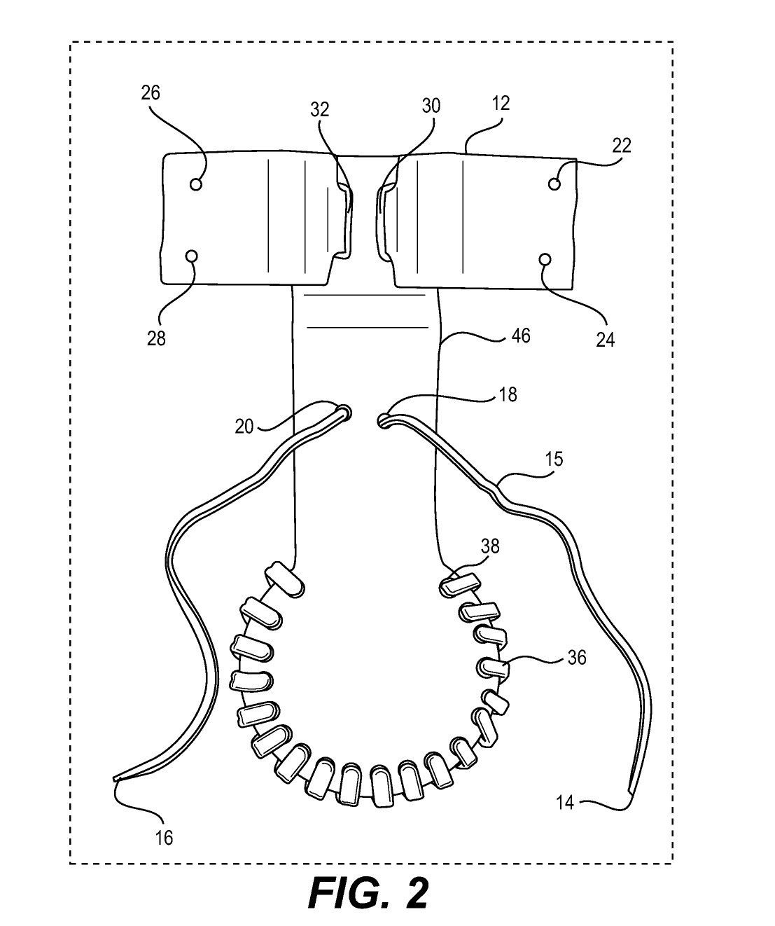

During manufacture, as best shown in FIG. 2, the left portion of the second leather piece 12 is inserted into and through the vertical slit 32 from the back of the first leather piece 46 so that the narrow portion of the second leather piece 12 rests in the vertical slit 32. The left portion of the second leather piece 12 the right portion of the second leather piece 12 is inserted into and through the vertical slit 30 from the back of the first leather piece 46 so that the narrow portion of the second leather piece 12 rests in the vertical slit 30.

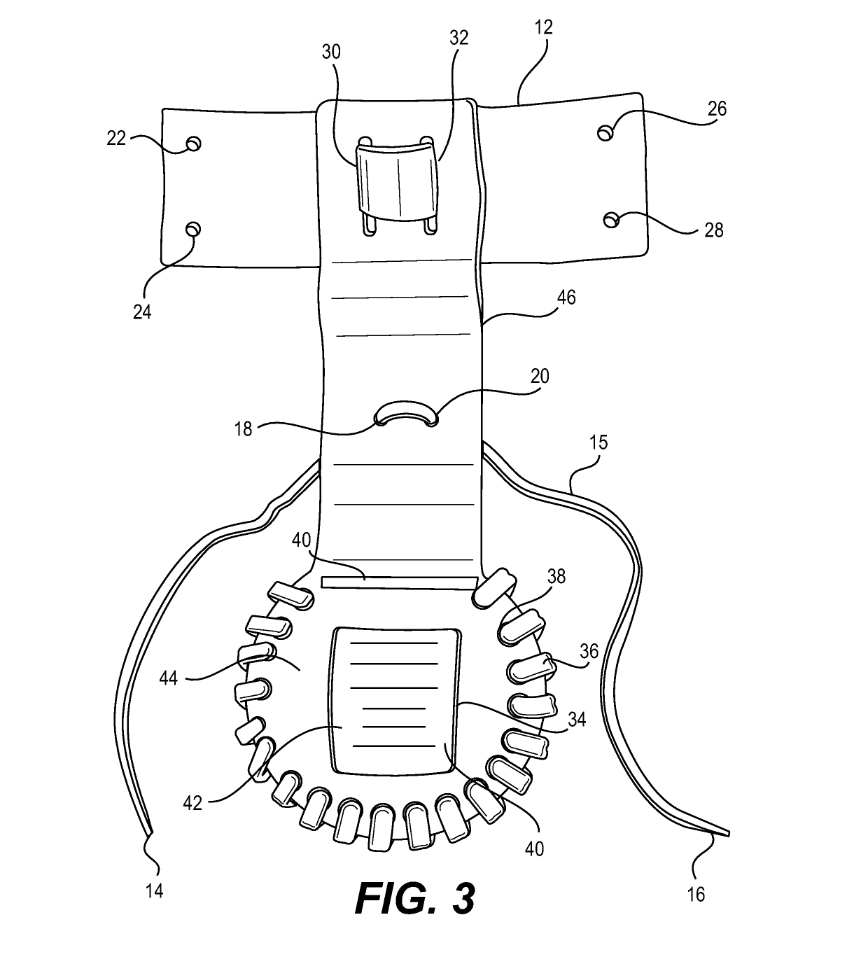

As shown in FIG. 3, the ballistic data holder 10 comprises a third piece of leather 44 cut in the shape of a partial circle with a hole 34 which enables the firearm user to view the ballistic data chart 40 through a clear plastic piece 42 cut into the same shape as the third piece of leather 44.

During manufacture, as best shown in FIG. 3, the third leather piece 44 and the clear piece of plastic 42 is attached to the back of the first leather piece 46 by punching multiple holes 38 through the third leather piece 44 through the clear plastic piece 42 and through the first leather piece 46 along the circular edge of the partial circle but without punching holes in the neck portion of the first leather piece 46. The clear plastic piece 42 is placed between the first leather piece 46 and the third leather piece 44 and a piece of leather lanyard 36 is then threaded through the holes 38 and thus securing the first leather piece 46 the clear plastic piece 42 and the third leather piece 44 together.

As shown in FIG. 4, the ballistic data holder is attached to the firearm by inserting the upper portion of the first leather piece 46 and the attached second leather piece 12 through a ring attached to the firearm, such as a those commonly used to secure a rifle's sling, and folded down behind the lower neck portion of the first leather piece 46 allowing one end of the lanyard 14 to be inserted through the hole punch 24 and the other end of the lanyard 16 to be inserted through the hole punch 28 so that the portion of the second leather piece 12 appearing on the right of the first leather piece 46 is folded onto the front of the first leather piece 46 and the portion of the second leather piece 12 appearing on the left of the first leather piece 46 is folded onto the front of the first leather piece 46

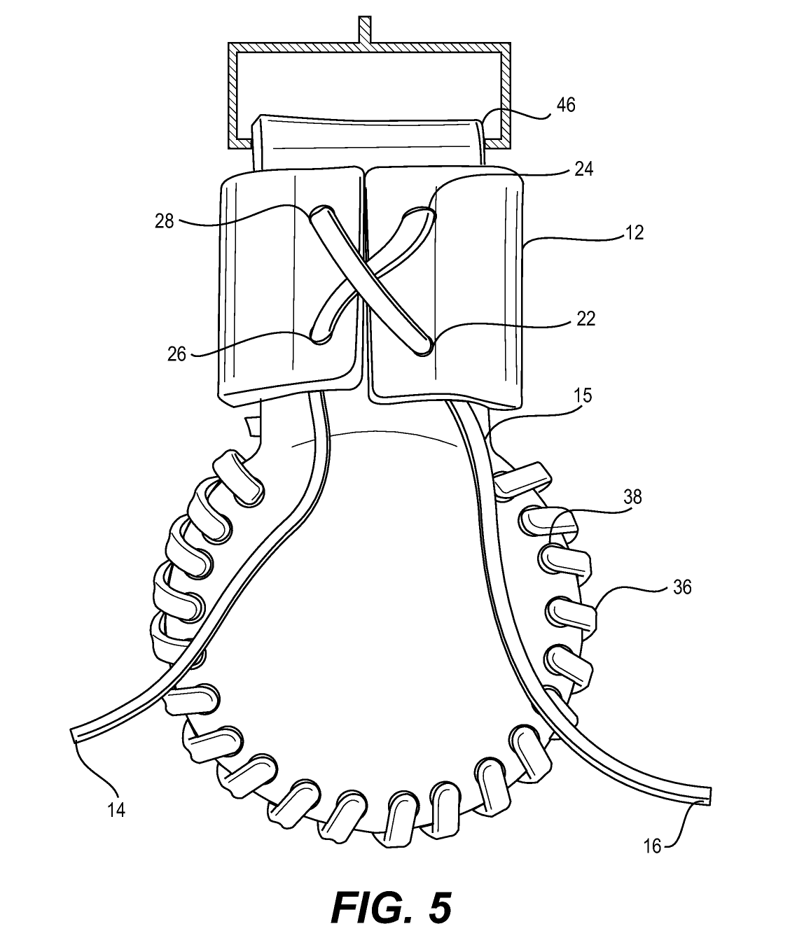

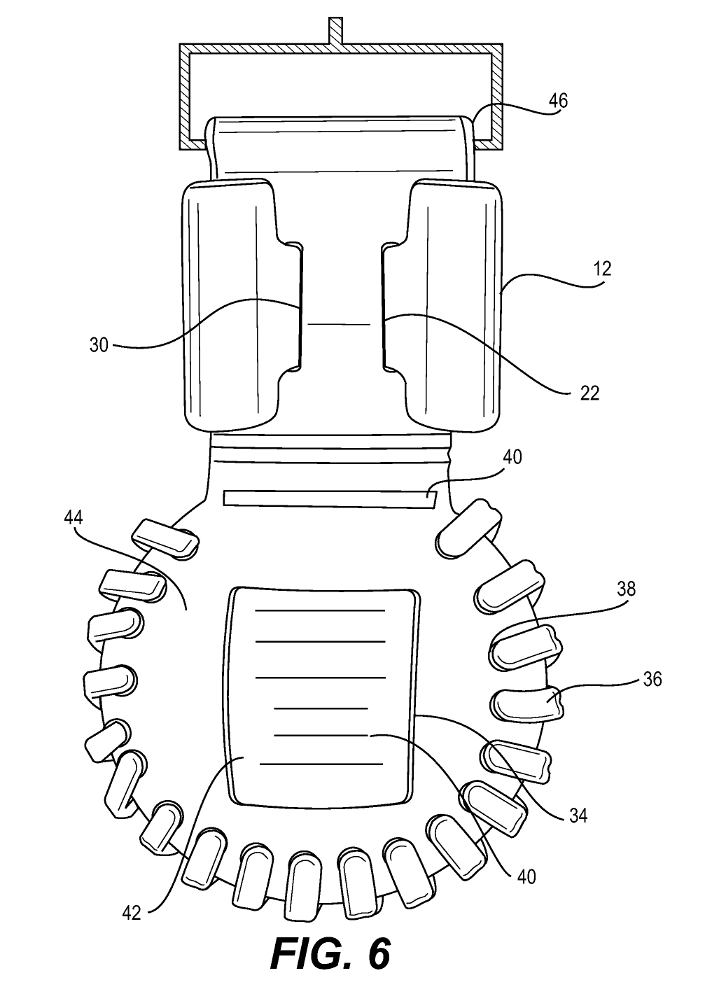

As shown in FIG. 5, one end of the lanyard 14 is then inserted into hole punch 26 and one end of the lanyard 16 is inserted into hole punch 22. As shown in FIG. 6, the ballistic data chart 40 is inserted down through the opening left by the process of attaching the first leather piece 46 the clear plastic piece 42 and the third leather piece 44 using the leather lanyard 36. The ballistic data chart 40 after being inserted is visible through the hole 34 and the clear plastic piece 42.

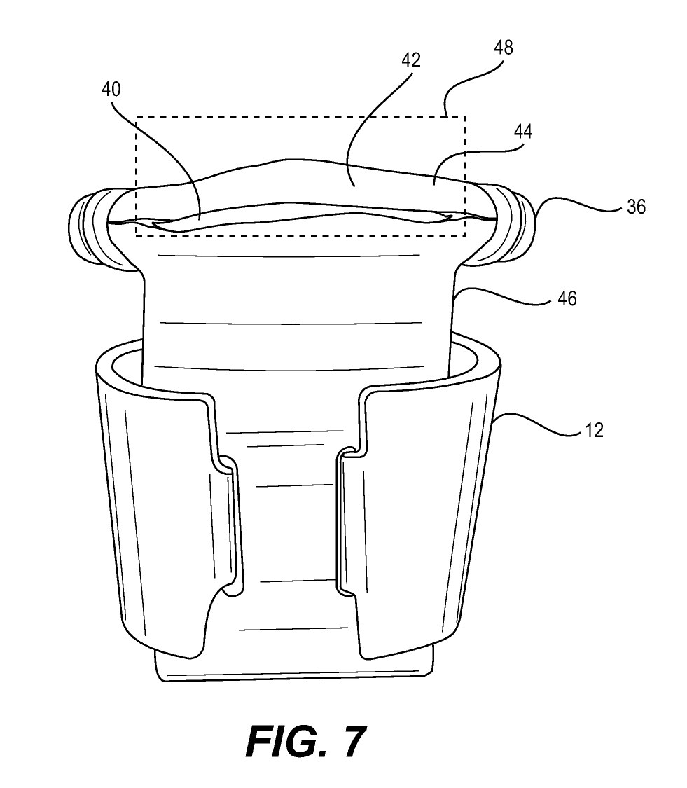

As shown in FIG. 7, the opening 48 is left along the neck of the first leather piece 46 allowing the ballistic data chart to be inserted between the first leather piece 46 and the clear plastic piece 42.

What is claimed is:

1. A ballistic data holder comprising:
a holder for an interchangeable card;
a card containing information related to a projectile's change in trajectory after being discharged from a firearm;
an area for viewing the card while it is secured in the holder;
an area allowing the card to be inserted and removed from the holder;
a means for attaching the holder to a firearm that permits the holder to be readily removed from and attached to a firearm.

2. The device of claim 1, wherein the information contained on the card represents a projectile's change in trajectory due to the effects of gravity over a given distance after being discharged from a firearm.

3. The device of claim 1, wherein the information contained on the card represents a projectile's change in trajectory due to the effects of wind over a given distance after being discharged from a firearm.

4. The device of claim 1, wherein the holder includes a first layer with one end having an area larger than the card and one end having an area of sufficient size to be capable of being secured to a firearm.

5. The device of claim 4, wherein the holder further includes a second layer of a translucent material having an area equal to the end that is larger than the card.

6. The device of claim 4, wherein the holder further includes a third layer having an area equal to the end that is larger than the card and that includes a viewing area.

7. The device of claim 1, wherein the three layers of the holder are secured together along the outside edge of the holder leaving an opening large enough for the card to be slid in between the first layer and the translucent layer so that it may be viewed through the viewing are included in the third layer.
